(19) United States
(12) Patent Application Publication
(10) Pub. No.: US 2010/0233566 A1
(43) Pub. Date: Sep. 16, 2010

(54) FUEL CELL AND FUEL CELL SYSTEM

(75) Inventor: Yuusuke Sato, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Minato-ku (JP)

(21) Appl. No.: 12/281,628

(22) PCT Filed: Jul. 31, 2008
(86) PCT No.: PCT/JP2008/002060

§ 371 Date: Sep. 4, 2008

(30) Foreign Application Priority Data
Sep. 12, 2007 (JP) 2007-237145

(51) Int. Cl. H01M 8/24; H01M 8/10

(52) U.S. Cl. 429/469; 429/483

(57) ABSTRACT

A fuel cell includes a cell stack in which a plurality of unit cells each including a membrane electrode assembly with an anode electrode and a cathode electrode, and an anode flow plate connected to the anode electrode, and a gap portion which supplies oxygen amount greater than or equal to a consuming oxygen amount of the cathode electrode by diffusion onto the cathode electrode surface, are provided on the cathode electrode surface; a container unit containing the cell stack, having one face and another face in a direction parallel to a stacking direction of the unit cells; a duct unit arranged on at least one of the one face and the another face, and connected to the gap portion, and a fan which supplies the oxygen to the duct unit.

### TECHNICAL FIELD

The present invention relates to a fuel cell and a fuel cell system.

### BACKGROUND ART

A direct type fuel cell for supplying liquid fuel such as alcohol directly to a power generation unit is expected to be utilized in a small power source of a portable device or the like, as there is no need for auxiliary devices such as a vaporizer and/or a reformer. In addition, in conjunction with the advance of the fuel cell technology, there are analysis methods for evaluating an electro-chemical behavior of the fuel cell (for instance, refer to JP-A 2005-44602 (KOKAI)).

The polymer electrolyte fuel cell (PEFC) that uses hydrogen as fuel or the direct methanol fuel cell (DMFC) has a stack in which unit cells are stacked, where a unit cell that is formed by sandwiching a membrane electrode assembly (MEA) with an anode flow plate and a cathode flow plate. The MEA is formed with a polymer electrolyte proton conductive membrane, an anode catalyst layer and an anode gas diffusion layer which are formed on an anode side of the proton conductive membrane, and a cathode catalyst layer and a cathode gas diffusion layer which are formed on a cathode side of the proton conductive membrane.

In the DMFC that utilizes mixed solution of water and methanol as fuel, the mixed solution of water and methanol is supplied to the anode electrode of the MEA via the anode flow. At the anode electrode, a reaction of the equation (1) occurs, and carbon dioxide is generated.

[Math.1]

CH₃OH+H₂O→CO₂+6H⁺+6e⁻ (1)

On the other hand, the air (oxygen) is supplied as oxidizer to the cathode electrode of the MEA. On the cathode electrode side, a reaction of the equation (2) occurs, and water is generated.

[Math.2]

3/2O₂+6H⁺+6e⁻→3H₂O (2)

A fuel cell type of supplying air to the cathode flow channel by an air pump is classified into an active type fuel cell in which air is supplied to the cathode electrode side by forced air flow by using an auxiliary device such as a pump. Another fuel cell type is a breathing type fuel cell in which oxygen is supplied to the cathode electrode side by utilizing the air circulation by natural convective flow and/or diffusion of the oxygen, without using the auxiliary device.

In the case of utilizing the active type, it is difficult to make a fuel cell system more compact because there is a need for an auxiliary device for supplying air to each unit cell. There are also problems of noises from a pump and power consumptions by a pump. Therefore an active type fuel cell has issues to utilize it as a compact size power source for the portable electronic device or the like.

On the other hand, by utilizing the breathing type fuel cell, it is possible to omit an air pump. Therefore, it becomes possible to make a fuel cell system compact. However, it becomes difficult to control air temperature and/or air humidity which is fed to a stack of a breathing type fuel cell. If optimum conditions for power generation of a stack are not be achieved, power generation density of each unit cell may become lowered and a power generation efficiency may become lowered.

Also, in the case of forming a stack by stacking unit cells of the breathing type fuel cell, air is not sufficiently supplied by oxygen diffusion and/or air convention because of limited air supply space compared with the case of arranging unit cells in plane. Therefore the performance of the unit cell and the power generation efficiency may be lowered.

### DISCLOSURE OF INVENTION

An aspect of the present invention inheres in a fuel cell encompassing a cell stack including a plurality of unit cells each including: a membrane electrode assembly with an anode electrode and a cathode electrode; an anode flow plate connected to the anode electrode; and a gap portion provided on a cathode electrode surface, supplying oxygen in concentration greater than or equal to a consuming oxygen amount of the cathode electrode by diffusion; a container unit containing the cell stack, having one face and another face in a direction parallel to a stacking direction of the unit cells; a duct unit arranged on at least one of the one face and the another face, and connected to the gap portion; and an oxidant supplying unit which supplies the oxygen to the duct unit.

Another aspect of the present invention inheres in a fuel cell encompassing a unit cell including a membrane electrode assembly with an anode electrode and a cathode electrode, and an anode flow plate connected to the anode electrode; and a plate on which a gap portion which supplies oxygen in concentration greater than or equal to a consuming oxygen amount of the cathode electrode by diffusion onto a cathode electrode surface is provided, on the cathode electrode surface.

Still another aspect of the present invention inheres in a fuel cell system encompassing a cell stack in which a plurality of unit cells each including: a membrane electrode assembly with an anode electrode and a cathode electrode; an anode flow plate connected to the anode electrode; and a gap portion provided on a cathode electrode surface, supplying oxygen in concentration greater than or equal to a consuming oxygen amount of the cathode electrode by diffusion; a container unit containing the cell stack, having one face and another face in a direction parallel to a stacking direction of the unit cells; a duct unit arranged on at least one of the one face and the another face, and connected to the gap portion; an oxidant supplying unit which supplies the oxygen to the duct unit; a mixing tank which stores fuel, configured to supply a mixture of exhausts ejected from the cell stack and high concentration fuel, to the cell stack; and a circulation pump configured to circulate the fuel to the cell stack.

### BRIEF DESCRIPTION OF THE DRAWINGS

FIG. 1 is a block diagram illustrating an example of a fuel cell system according to an embodiment.

FIG. 2 is a perspective view illustrating an example of a fuel cell of FIG. 1.

FIG. 3 is a cross-sectional view seen from a line A-A in FIG. 2.

FIG. 4 is a cross-sectional view seen from a line B-B in FIG. 2.

FIG. 5A is a schematic view illustrating an example of a unit cell.

FIG. 5B is a plane view seen from a surface of a cathode electrode.

FIG. 6 is an explanatory diagram seen from a y-z direction of FIG. 2, illustrating oxygen concentration change at a gap portion between a unit cell 2a and a unit cell 2b.

FIG. 7 is a graph illustrating a relation ship between a length L of a unit cell and oxygen concentration change.

FIG. 8 is a graph illustrating a relationship between a current density and a distance h, by fixing a length L of a cathode electrode to 0.4 cm in a fuel cell.

FIG. 9 is a cross-sectional view illustrating an example of a fuel cell according to a first modification.

FIG. 10 is a cross-sectional view seen from a z-x direction of FIG. 9.

FIG. 11 is a cross-sectional view illustrating an example of a fuel cell according to a second modification.

FIG. 12 is a cross-sectional view illustrating an example of a fuel cell according to a third modification.

FIG. 13 is a cross-sectional view illustrating an example of a fuel cell according to other embodiments.

FIG. 14 is a cross-sectional view illustrating an example of a fuel cell according to the other embodiments.

FIG. 15 is a cross-sectional view seen from a z-x direction of FIG. 14.

FIG. 16 is a cross-sectional view illustrating an example of a fuel cell according to the other embodiments.

FIG. 17 is a cross-sectional view illustrating an example of a fuel cell according to the other embodiment.

FIG. 18 is a cross-sectional view seen from a line c-c of FIG. 17, according to the other embodiments.

### BEST MODE FOR CARRYING OUT THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified. In the following descriptions, numerous details are set forth such as specific signal values, etc. to provide a thorough understanding of the present invention. However, it will be obvious to those skilled in the art that the present invention may be practiced without such specific details.

(Fuel Cell System)

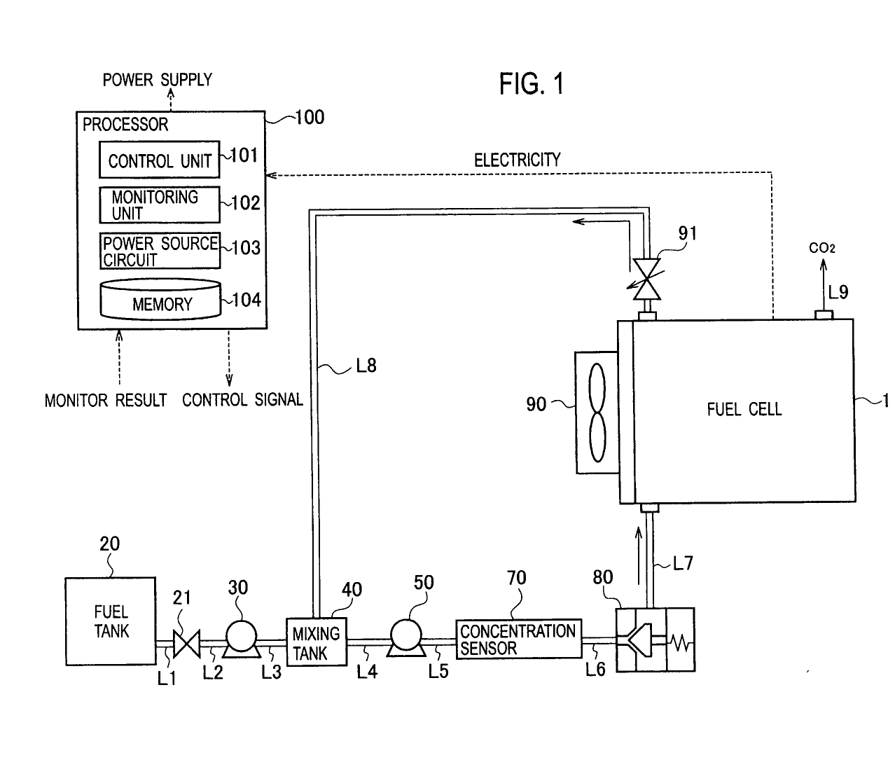

As shown in FIG. 1, a fuel cell system according an embodiment of the present invention has a fuel cell 1, a mixing tank 40 for preparing the fuel to be supplied to the fuel cell 1 by mixing the exhaust ejected from the fuel cell 1 and the high concentration fuel stored in a fuel tank 20, a circulation pump 50 for circulating the fuel to the fuel cell 1, and a processor 100 for controlling a series of operations of the fuel cell system.

The fuel tank 20 is connected to a control valve 21 via a line L1. The control valve 21 is connected to a fuel pump 30 via a line L2. The fuel pump 30 is connected to the mixing tank 40 via a line L3. The mixing tank 40 is connected to a circulation pump 50 via a line L4. The circulation pump 50 is connected to a concentration sensor via a line L5. The concentration sensor 70 is connected to a pressure adjustment mechanism 80 via a line L6. The pressure adjustment mechanism 80 is connected to the fuel cell 1 via a line L7.

A fan 90 for supplying air (oxygen) is connected to the fuel cell 1. A needle valve 91 is arranged on the exit side of an anode flow path of the fuel cell 1. The needle valve 91 is connected to the mixing tank 40 via a line L8. A line L9 for ejecting byproduct gas such as carbon dioxide separated from anode liquid to an external of the fuel cell 1 is connected to the exit side of a flow on a cathode side of the fuel cell 1.

For the high concentration fuel in the fuel tank 20, the methanol liquid which concentration is higher than 99.9%, or methanol/water mixture of methanol concentration greater than or equal to 10 mol/L and water can be utilized. The high concentration fuel is supplied from the fuel tank 20 to the mixing tank 40 via the line L1, the control valve 21, the line L2 and the line L3.

Various sensors may be provided on the mixing tank 40. As a sensor, it is possible to use a liquid level sensor for detecting a remaining amount of fuel mixture by measuring a height of a liquid surface of the fuel, or an inclination sensor for measuring a level of inclination of the mixing tank 40, etc. The detection results of the sensors are inputted to the processor 100.

The circulation pump 50 supplies the fuel from the mixing tank 40 to the fuel cell 1 via the lines L4, L5, L6 and L7, and circulates the exhaust ejected from the fuel cell 1 to the mixing tank 40 via the line L8.

The concentration sensor 70 monitors the concentration of the fuel flowing between the lines L5 and L6, and outputs a monitored result to the processor 100. The pressure adjustment mechanism 80 adjusts a pressure of the fuel to the fuel cell 1 via the line L7.

The processor 100 controls an operation of the power generation by the fuel cell 1 in order to supply power to target devices, and operations of various devices within the fuel cell system, etc., for example. The processor 100 includes at least a control unit 101, a monitoring unit 102, and a power source circuit 103.

The control unit 101 outputs control signals to the control valve 21, the fuel pump 30, the circulation pump 50, the concentration sensor 70, the pressure adjustment mechanism 80, the fuel cell 1 and the fan 90, etc., for example, and controls operations of various devices. And, it controls a supply of the power obtained from the fuel cell 1 to the power supply target devices. The monitoring unit 102 monitors a fuel concentration detected by the concentration sensor 70, and the monitored results such as a temperature, a pressure, a flowing amount, etc. outputted from various detectors provided within the fuel cell system. The power source circuit 103 generates the power to be supplied to the auxiliary devices such as the fuel pump 30 or the circulation pump 50, etc., for example, or converts the power to be supplied to the power supply target devices by raising or lowering the voltage supplied from the fuel cell 1. A memory 104 for storing various process data and programs may be mounted on the processor 100.

(Fuel Cell)

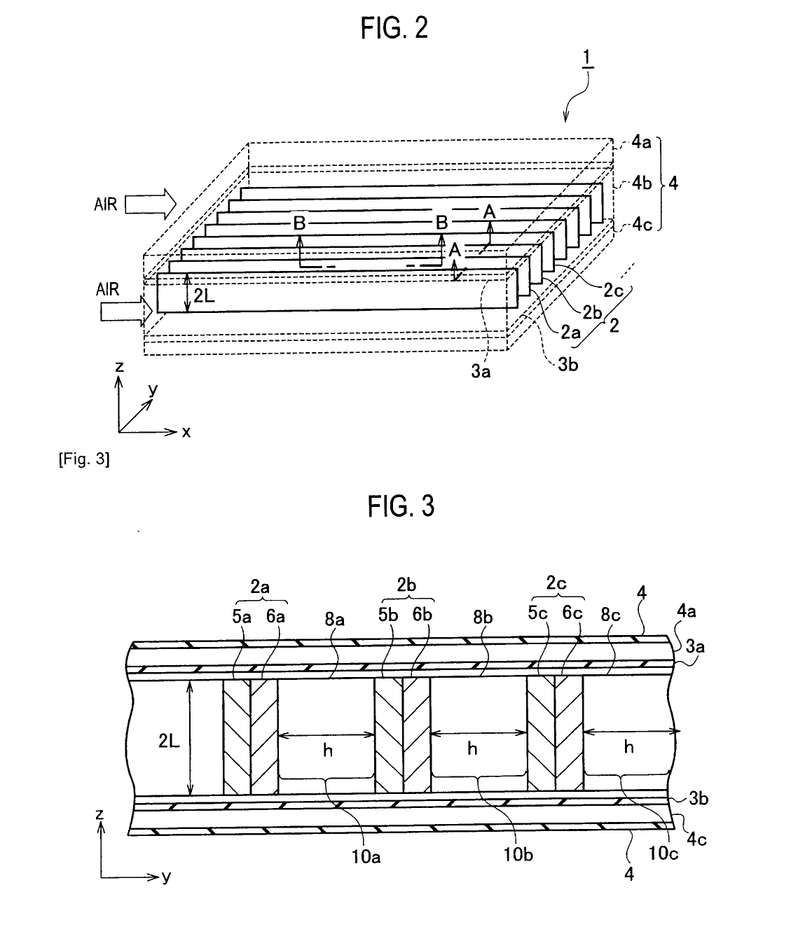

As shown in FIG. 2, the fuel cell 1 includes a cell stack 2 in which a plurality of unit cells (the first unit cell 2a, the second unit cell 2b, the third unit cell 2c, . . . ) are stacked in a direction of a y-axis in the figure (a direction substantially parallel to an upper face and a lower face of a container 4 in the case where a direction of an arrow along the z-axis in the figure is regarded as upward). The cell stack 2 is contained inside a container 4.

The container 4 is partitioned into a duct unit 4a, a containing unit 4b and a duct unit 4c by diaphragms 3a and 3b. The duct units 4a and 4c are spaces for circulating air supplied from the fan 90 of FIG. 1. The containing unit 4b is a space for containing the cell stack 2. For the diaphragms 3a and 3b, thin films or the like made of porous resin that can permeate air can be used.

By arranging the diaphragms 3a and 3b inside the container 4, it becomes possible to appropriately maintain the humidity of the cathode spaces of the unit cells 2a, 2b, 2c, . . . , even in the case of supplying air to the duct units 4a and 4c from the fan 90. Note that there is no need to arrange the diaphragms 3a and 3b in the case where it is possible to maintain the humidity of the cathode spaces even when air is supplied to the duct units 4a and 4c from the fan 90. Instead of arranging the duct units 4a and 4c, it may be possible to provide a space open to the external atmosphere around the containing unit 4b.

As shown in FIG. 3, the first unit cell 2a has a first membrane electrode assembly (MEA) 6a with an anode electrode and a cathode electrode, and a first anode flow plate 5a connected to the anode electrode of the first MEA 6a. The second unit cell 2b has a second MEA 6b with an anode electrode and a cathode electrode, and a second anode flow plate 5b connected to the anode electrode of the second MEA 6b. The third unit cell 2c has a third MEA 6c with an anode electrode and a cathode electrode, and a third anode flow plate 5c connected to the anode electrode of the third MEA 6c. The first MEA 6a, the second MEA 6b, and the third MEA 6c have a length 2L in the z-direction.

Between the cathode electrode of the first MEA 6a and the second anode flow plate 5b, a gap portion 10a having a distance h is formed. Between the cathode electrode of the second MEA 6b and the third anode flow plate 5c, a gap portion 10b having a distance h is formed. Between the cathode electrode of the third MEA 6c and the fourth anode flow plate (not shown), a gap portion 10c having a distance h is formed. The gap portions 10a, 10b and 10c make enough oxygen supply be possible by oxygen diffusion to the cathode catalyst layer from the duct units 4a and 4c through the diaphragms 3a and 3b to the gap portions 10a, 10b and 10c.

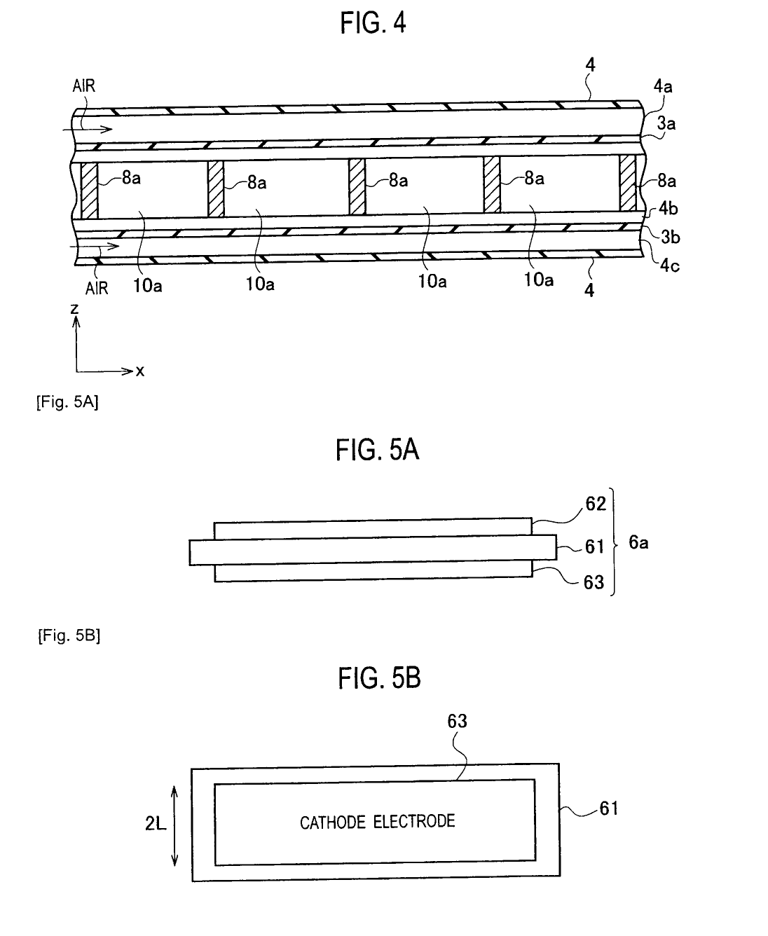

As shown in FIG. 4, inside the gap portion 10a, a contact (cathode flow plate) 8a for electrically connecting the first unit cell 2a and the second unit cell 2b is arranged. As shown in FIG. 3, inside the gap portion 10b, a contact (cathode flow plate) 8b for electrically connecting the second unit cell 2b and the third unit cell 2c is arranged. Inside the gap portion 10c, a contact (cathode flow plate) 8c for electrically connecting the third unit cell 2c and the fourth unit cell (not shown) is arranged. The shapes of the contacts 8a, 8b and 8c are not particularly limited.

In this way, by forming the gap portions 10a, 10b and 10c having a distance h on the cathode electrode surfaces of the first to third MEA 6a, 6b and 6c, it is possible to sufficiently supply air (oxygen) as the oxidizing agent to the first to third MEA 6a, 6b and 6c due to oxygen diffusion across the gap portions 10a, 10b and 10c through the permeation and diffusion of the gaseous body by utilizing the air flow of duct units 4a and 4c. As a result, conventionally used the auxiliary devices such as an air pump necessary for supplying air onto the cathode electrode surface through cathode flow channels can be eliminated, so that it becomes possible to make the fuel cell system compact because pressure drop of flow of duct units 4a and 4c is much less than conventional cathode flow channel. A small fan whose power consumption and noise are much less than those of an air pump can be used for air supply.

An exemplary configuration of the first MEA 6a is shown in FIG. 5A. The first MEA 6a has a proton conductive membrane 61, and an anode electrode 62 and a cathode electrode 63 that are facing each other through the proton conductive membrane 61. The proton conductive membrane 61 is larger than an area of the cathode electrode 63, as sealing portions with respect to the other members are formed. In the embodiment of the present invention, the length 2L (or L) is defined as a length of the cathode electrode 63, rather than a length of the proton conductive membrane 61 or the first MEA 6a as a whole.

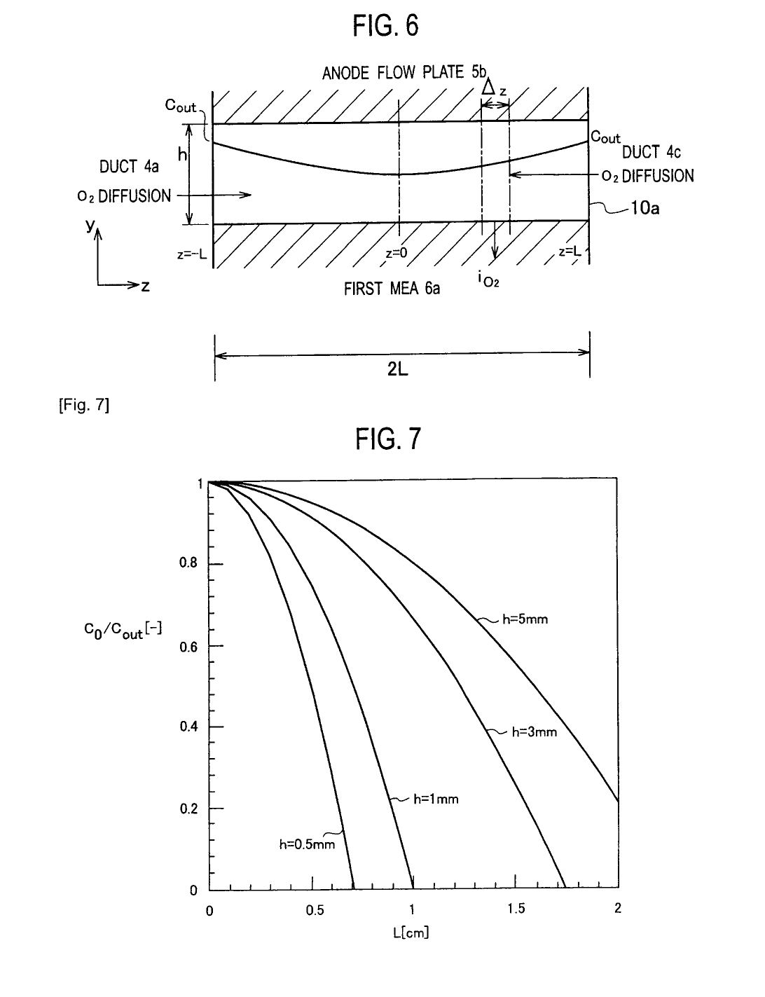

In FIG. 6, a model of the oxygen concentration profile at the gap portion 10a formed between the first MEA 6a and the second anode flow plate 5b is shown. In the example of FIG. 6, both ends of the gap portion 10a are connected to the duct units 4a and 4c, When a distance in the y-direction on the gap portion 10a at this point is h, a length in the z-direction of the cathode electrode of the first MEA 6a that is facing against the gap portion 10a is defined as 2L.

When it is assumed that the oxygen concentration of the air flowing through the duct units 4a and 4c are uniform, the oxygen will be consumed at the cathode electrode according to the equation (2) described above, in proportion to the current density i. Note that the current density i in following equations contains oxygen consumption effect by methanol crossover flux as the methanol crossovers to the cathode electrode 63 through the proton conductive membrane 61 and is consumed by the reaction with the oxygen:

[Math.3]

CH₃OH+1.5O₂→2H₂O+CO₂ (3)

Assuming that the consumption amount of the oxygen on the cathode electrode surface is uniform in the z-direction, no flow inside gaps, and considering oxygen flux caused by oxygen concentration profile, a differential equation and the boundary condition (B.C.) shown in the equation (4) can be obtained from the material balance of oxygen.

[Math.4]

∂²C/∂z²=i/(4FhD_{O2}), B.C. ∂C/∂z(0)=0, C(L)=Cₒᵤₜ (4)

where F is a Faraday constant, D_{O2} is a diffusion coefficient of oxygen, and Cₒᵤₜ is an oxygen concentration of the duct unit. By integrating the equation (4), the oxygen distribution concentration of the gap portion 10a formed between the first MEA 6a and the second anode flow plate 5b, for example, is expressed by the equation (5).

C(z)=i(z²−L²)/(8FhD_{O2})+Cₒᵤₜ (5)

FIG. 7 shows the oxygen concentration profile normalized by Cₒᵤₜ inside gap portion 10a, using a distance h as a parameter, under the temperature of 60 degrees Celsius, the current density i of 150 mA/cm², the diffusion coefficient of oxygen D_{O2} at 60 degrees Celsius as 0.26 cm²/s, and the oxygen concentration Cₒᵤₜ as 7.7E-6 mol/cm³.

Furthermore, by substituting the condition of C(z)>0 at Z=0(at the center of gap) into the equation (4), the condition of distance which the oxygen can be supplied by the diffusion is expressed by the equation (6).

L<((8FhD_{O2})Cₒᵤₜ/i)^{0.5} (6)

Consequently, when a size of L is set longer than L that satisfies the equation (5), there appears a region in which the oxygen supplied onto a surface of the cathode electrode 63 of the MEA becomes insufficient. At a portion where the oxygen is insufficient, the power generation reaction does not progress sufficiently. On the other hand, the electric conductivity of the anode flow plates 5a to 5c and the contact 8a to 8c that sandwich the MEA 6a to 6c is high, so that the unit cell as a whole becomes nearly equal voltage. As a result, in the case that the oxygen is insufficiently supplied, cell voltage becomes nearly 0. In the case where the fuel are supplied continuously even when the voltage becomes nearly 0, the amount of fuel wastefully consumed without generating the power will be increased abruptly. As a result, the fuel utilization efficiency will also be lowered. Also, in the case where other unit cells are generating the electromotive force, if the currents are forcefully fed even to a unit cell with a nearly 0 voltage, a phenomenon in which the unit cell is caused to make a polarity inversion or destroyed may occur, so that there can be cases where the fuel cell 1 as a whole is damaged.

In contrast to this, according to the fuel cell 1 having a relationship that satisfies the equation (5), the oxygen in excess of the oxygen concentration consumed by the cathode electrode can be supplied onto the cathode electrode surface by the diffusion, so that it is possible to suppress the formation of an oxygen depleted region on the cathode electrode surface. As a result, it is possible to suppress the performance degradation of the unit cell, it is possible to suppress the wasteful consumption of the fuel, and it is possible to increase the power generation efficiency. For example, in the case of the fuel cell 1 in which the distance h of the gap portions 10a, 10b and 10c of FIG. 3 is set to 1 mm, and the length 2L of the cathode electrode of the first to third unit cells 2a, 2b and 2c is set to 15 mm, it is possible to carry out the good power generation.

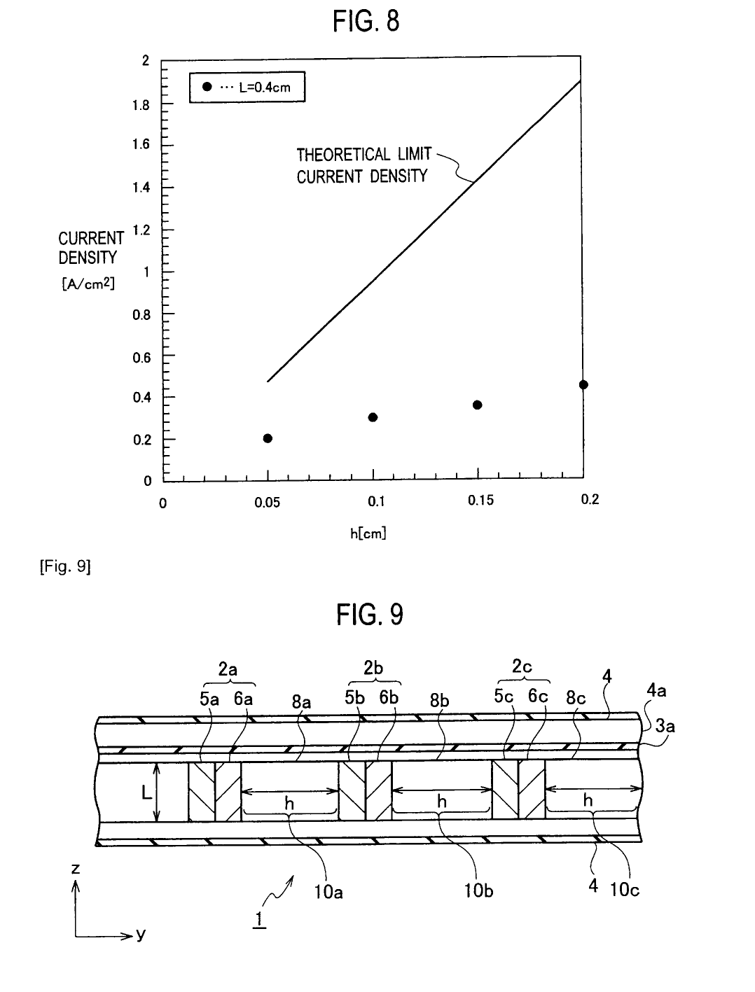

FIG. 8 shows an experimental result of the current density in the case where the distance h of the gap portion is changed, by fixing the length L of the cathode electrode to 0.4 cm in the fuel cell 1 shown in FIG. 2. In FIG. 8, a solid line indicates the theoretical limit current density in the case where the length L is set to 0.4 cm under the running condition similar to that of the case shown in FIG. 7. Regions with the current density lower than the solid line of FIG. 8 indicate portions at which the oxygen density does not become 0 among the regions of z=0 in FIG. 6. As can be seen from the result of FIG. 8, in any of the cases where the experiments are conducted by setting the distance h as 0.05 cm, 0.1 cm, 0.15 cm and 0.2 cm, it can be recognized that experimental current density is smaller than the theoretical limit current density. Therefore L should satisfy Eq.(6).

(First Modification)

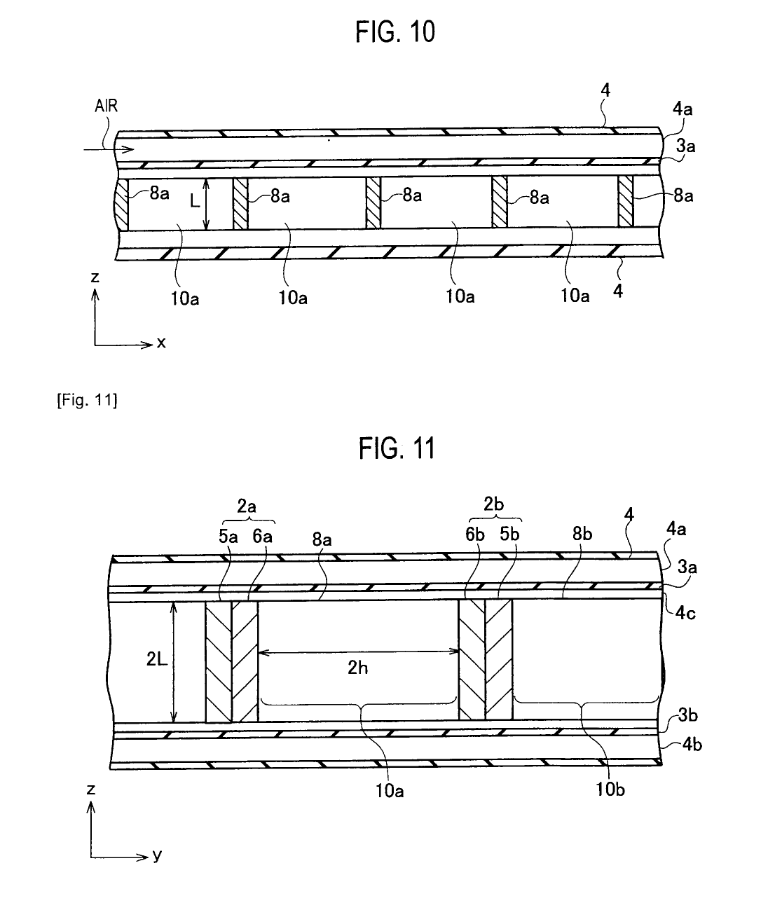

As shown in FIG. 9 and FIG. 10, the fuel cell 1 according to the first modification differs from the fuel cell 1 shown in FIG. 3 and FIG. 4 in that the duct unit 4a for supplying the air to the unit cells 2a, 2b and 2c is arranged only on one surface side of the container 4.

The cathode electrode of the first MEA 6a and the second anode flow plate 5b are separated by the distance h through the contact 8a, and arranged such that a certain space (the gap portion 10a) is given with respect to a surface of the cathode electrode of the first MEA 6a. The cathode electrode of the second MEA 6b and the third anode flow plate 5c are separated by the distance h through the contact 8b, and arranged such that a certain space (the gap portion 10b) is given with respect to a surface of the cathode electrode of the second MEA 6b. The cathode electrode of the third MEA 6c and the anode flow plate (not shown) that is facing against that cathode electrode are separated by the distance h through the contact 8c, and arranged such that a certain space (the gap portion 10c) is given with respect to a surface of the cathode electrode of the third MEA 6c.

In this way, by arranging the gap portions 10a, 10b and 10c defined by the distance h with respect to the cathode electrode surface, through the contacts 8a, 8b and 8c, it is possible to supply the air to the cathode electrode side by utilizing the air circulation due to the permeation and the diffusion of the gaseous body, even when the auxiliary devices such as pump are eliminated. Note that, in an example shown in FIG. 9 and FIG. 10, the duct units 4a and 4c are arranged only on one surface side of the container 4, so that at a time of applying the equation (5), the length of the electrode in the z-direction of the first MEA 6a, the second MEA 6b and the third MEA 6c is defined to be L.

(Second Modification)

As shown in FIG. 11, the fuel cell 1 according to the second modification differs from the fuel cell 1 shown in FIG. 3 and FIG. 4 in that the cathode electrode of the first MEA 6a and the cathode electrode of the second MEA6b are arranged to be facing each other through a distance 2h.

According to the fuel cell 1 shown in FIG. 11, the gap portion defined by the distance 2h is formed between the cathode electrode of the first unit cell 2a and the cathode electrode of the second unit cell 2b, so that it is possible to supply the oxygen in excess to the consumption oxygen concentration to the cathode electrode side by utilizing the air circulation due to the permeation and the diffusion of the gaseous body, even when the auxiliary devices such as pump are eliminated, and it is possible to achieve the fuel cell 1 capable of maintaining the performance of the unit cell and the power generation efficiency high and the fuel cell system utilizing the fuel cell 1.

(Third Modification)

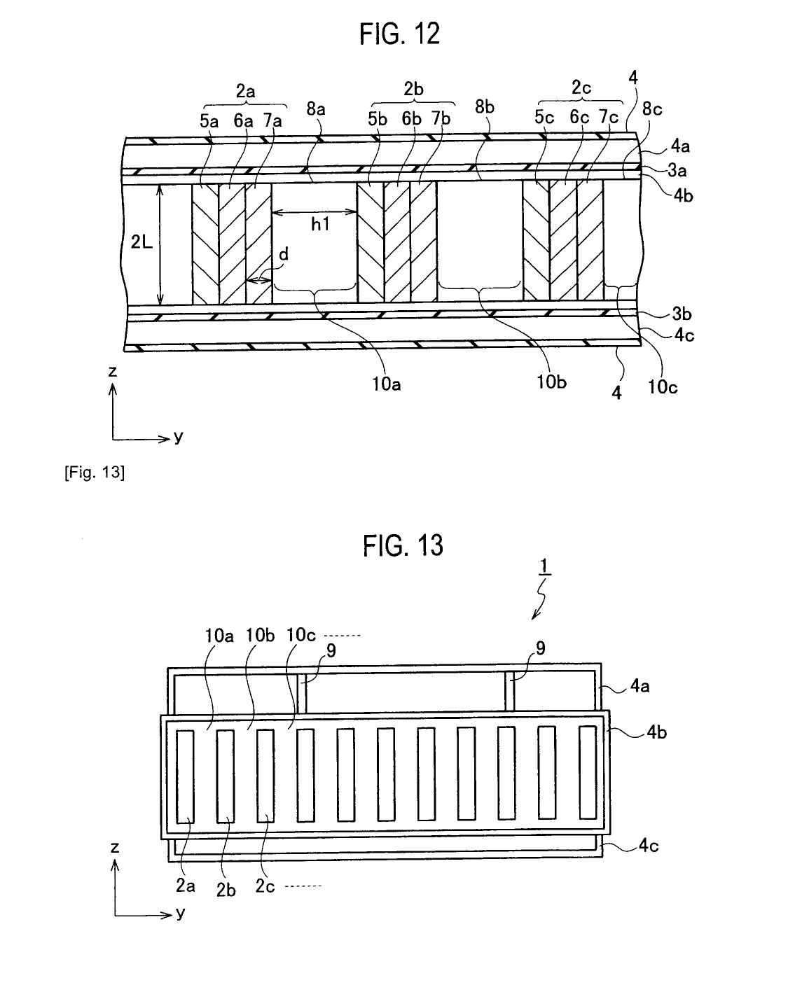

As shown in FIG. 12, the fuel cell 1 according to the third modification differs from the fuel cell 1 shown in FIG. 3 and FIG. 4 in that the each of the first unit cell 2a, the second unit cell 2b, the third unit cell 2c, etc., has porous bodies 7a, 7b, 7c, etc.

The porous body 7a is arranged on the cathode electrode side of the first MEA 6a. The porous body 7b is arranged on the cathode electrode side of the second MEA 6b. The porous body 7c is arranged on the cathode electrode side of the third MEA 6c. For the porous bodies 7a, 7b and 7c, it is possible to use a porous material having pores, such as carbon paper, carbon cloth or the like having pore diameter of several micrometer, for example. For example, when the porosity of the porous body 7a is epsilon, a thickness is d, and a distance from a surface of a face facing against the cathode electrode side of the first MEA 6a of the porous body 7a to the second anode flow plate 5b is h1, it is preferable to determine sizes of the first to third MEA 6a, 6b and 6c such that a relationship of the following equation (6) is satisfied, in addition to the equation (5) described above.

h=h1+epsilon d (6)

According to the fuel cell 1 shown in FIG. 12, as the unit cells 2a, 2b and 2c in sizes satisfying the equation (5) and the equation (6) are arranged, so that it is possible to achieve the fuel cell 1 capable of maintaining the performance and the power generation efficiency high and the fuel cell system utilizing the fuel cell 1.

### Other Embodiments

As shown in FIG. 13, a radiator fin 9 for radiating heats of the unit cells 2a, 2b and 2c and thermally connecting the unit cells 2a, 2b 2c, etc., may be formed inside the duct unit 4a of the fuel cell 1.

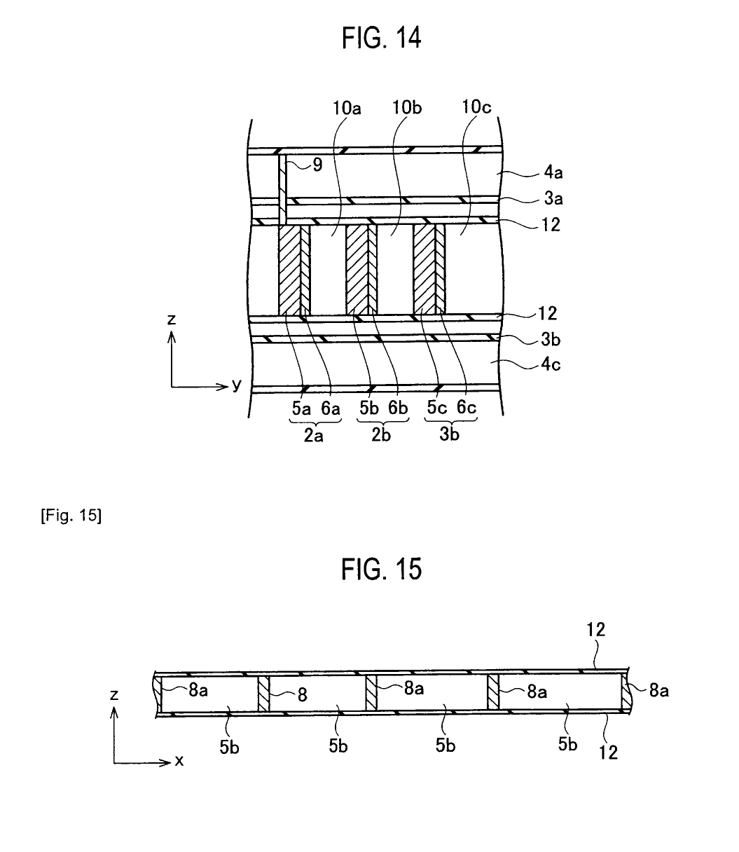

A shape of the radiator fin 9 may be formed by extending a part of the anode flow plate 5a, as shown in FIG. 14, for example. The radiator fin may be formed by extending a part of the contact not shown in the figure to the duct units 4a and 4c side. Also, as shown in FIG. 14 and FIG. 15, the edge portions of the unit cells 2a, 2b and 2c may be covered by a porous structure 12 in order to make it easier to manage the temperature and the humidity of the fuel cell 1.

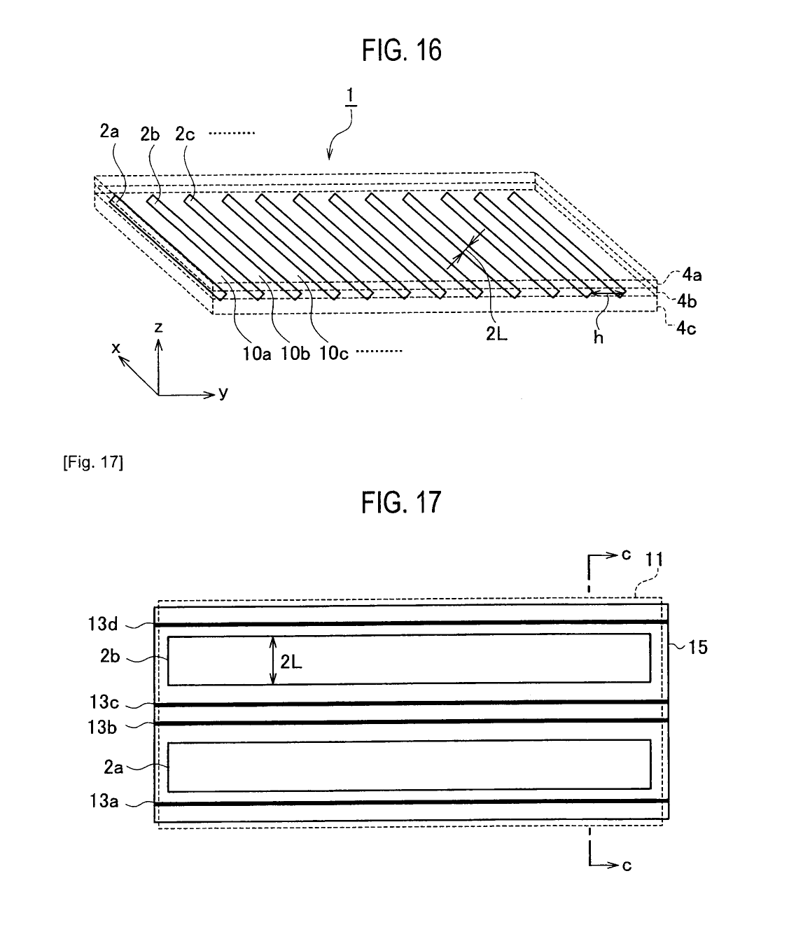

As shown in FIG. 16, the fuel cell 1 can be made thinner by arranging the unit cells 2a, 2b and 2c having a width 2L obliquely with respect to a lower face of the container unit 4b respectively, with a separation of roughly a distance h between the unit cells 2a, 2b and 2c.

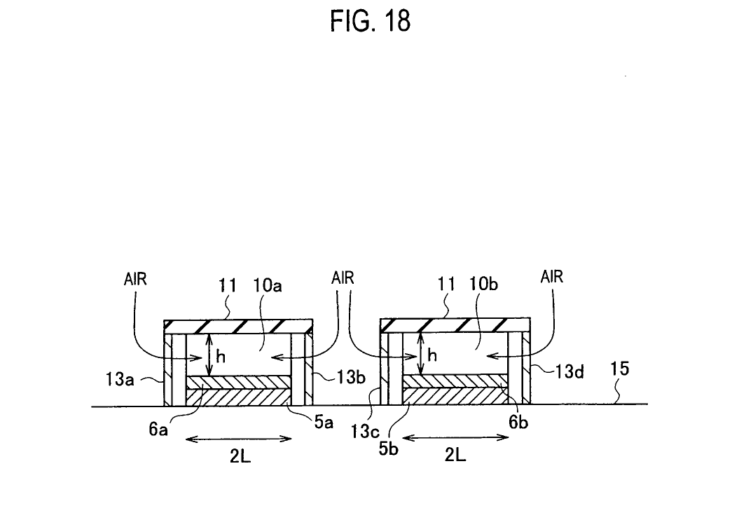

In the case of arranging the first unit cell 2a and the second unit cell 2b flatly on a flat plate 15 as shown in FIG. 17, a plate 11 is arranged such that it has the gap portions 10a and 10b with the distance h upwards from the first MEA 6a and the second MEA 6b, as shown in FIG. 18. As shown in FIG. 18, diaphragms 13a, 13b, 13c and 13d are formed around the first MEA 6a and the second MEA 6b, and the air (oxygen) is supplied to the gap portions 10a and 10b through the diaphragms 13a, 13b, 13c and 13d. By using such a configuration, it is possible to supply the air to the cathode electrode side of the first MEA 6a and the second MEA 6b by utilizing the natural air convection due to the permeation and the diffusion of the gaseous body, even when the auxiliary devices such as an air pump are eliminated, and it is possible to prevent the cathode electrode from becoming too dry. It also becomes possible to reduce the drying of the cathode electrode, even in the case where the temperature of the first unit cell 2a and the second unit cell 2b is high.

Also, in the fuel cell 1 shown in FIG. 1 to FIG. 17, an exemplary case in which the anode flow plate and the anode electrode are directly connected is shown, but according to the need, it is also possible to insert porous body or the like between the anode flow plate and the anode electrode.

Additional advantages and modifications will readily occur to those skilled in the art. Therefore, the invention in its broader aspects is not limited to the specific details and representative embodiments shown and described herein. The entire contents of Japanese Patent Application P2007-237145 filed on Sep. 12, 2007 are incorporated by reference herein. Various modifications may be made without departing from the spirit or scope of the general inventive concept as defined by the appended claims and their equivalents.

1. A fuel cell comprising:
a cell stack including a plurality of unit cells each including:
a membrane electrode assembly with an anode electrode and a cathode electrode;
an anode flow plate connected to the anode electrode; and
a gap portion provided on a cathode electrode surface, supplying oxygen in concentration greater than or equal to a consuming oxygen amount of the cathode electrode by diffusion;
a container unit containing the cell stack, having one face and another face in a direction parallel to a stacking direction of the unit cells;
a duct unit arranged on at least one of the one face and the another face, and connected to the gap portion; and
an oxidant supplying unit which supplies the oxygen to the duct unit.

2. The fuel cell of claim 1, wherein the cell stack comprises:
a first unit cell including a first membrane electrode assembly with a first anode electrode and a first cathode electrode, and a first anode flow plate connected to the first anode electrode;
a second unit cell including a second membrane electrode assembly with a second anode electrode and a second cathode electrode, and a second anode flow plate connected to the second anode electrode and facing against the first cathode electrode; and
a contact arranged at a gap portion between the first cathode electrode and the second anode flow plate, electrically connecting the first unit cell and the second unit cell; and
wherein the cell stack satisfies a relationship of
L<((8FhD_{O2})Cₒᵤₜ/i)^{0.5}
where F is a Faraday constant, D_{O2} is a diffusion coefficient of oxygen, Cₒᵤₜ is an oxygen concentration of atmosphere, i is a current density at a time of power generation including oxygen consumption effect by crossover fuel, h is a distance of the gap portion between the first cathode electrode and the second anode flow plate, and a length of the first cathode electrode in a direction perpendicular to the another face is L when the first cathode electrode is connected to the duct unit on one of the one face and the another face, or 2L when the first cathode electrode is connected to duct units on the one face and the another face.

3. The fuel cell of claim 1, wherein the cell stack comprises:
a first unit cell including a first membrane electrode assembly with a first anode electrode and a first cathode electrode, and a first anode flow plate connected to the first anode electrode;
a second unit cell including a second membrane electrode assembly with a second anode electrode and a second cathode electrode, and a second anode flow plate connected to the second anode electrode, the second cathode electrode facing against the first cathode electrode; and
a contact arranged at a gap portion between the first cathode electrode and the second cathode electrode, electrically connecting the first unit cell and the second unit cell; and
wherein the cell stack satisfies a relationship of
L<((8FhD_{O2})Cₒᵤₜ/i)^{0.5}
where F is a Faraday constant, D_{O2} is a diffusion coefficient of oxygen, Cₒᵤₜ is an oxygen concentration of atmosphere, i is a current density at a time of power generation including oxygen consumption effect by crossover fuel, 2h is a distance of the gap portion between the first cathode electrode and the second cathode electrode, and each length of a first cathode electrode and a second cathode electrode in a direction perpendicular to the another face is L when the first cathode electrode and the second cathode electrode are connected to the duct unit on one of the one face and the another face, or 2L when the first cathode electrode and the second cathode electrode are connected to duct units on the one face and the another face.

4. The fuel cell of claim 2, further comprising:
a porous member in contact with the first cathode electrode, which satisfies a relationship of h=h1+epsilon d, where epsilon is a porosity of the porous member, d is a thickness of the porous member, and h1 is a distance of the gap portion between a surface of the porous member and the second anode flow plate.

5. The fuel cell of claim 1, further comprising a diaphragm formed between the duct unit and the container unit.

6. The fuel cell of claim 1, further comprising a radiator fin disposed in the duct unit.

7. A fuel cell comprising:
a unit cell including a membrane electrode assembly with an anode electrode and
a cathode electrode, and an anode flow plate connected to the anode electrode; and
a plate on which a gap portion which supplies oxygen in concentration greater than or equal to a consuming oxygen amount of the cathode electrode by diffusion onto a cathode electrode surface is provided, on the cathode electrode surface.

8. The fuel cell of claim 7, wherein the unit cell satisfies a relationship of
L<((8FhD_{O2})Cₒᵤₜ/i)^{0.5}
where F is a Faraday constant, D_{O2} is a diffusion coefficient of oxygen, Cₒᵤₜ is an oxygen concentration of atmosphere, i is a current density at a time of power generation including oxygen consumption effect by crossover fuel, h is a distance of the gap portion between the cathode electrode and the plate, and a length of the cathode electrode is 2L.

9. A fuel cell system, comprising:
a cell stack in which a plurality of unit cells each including:
a membrane electrode assembly with an anode electrode and a cathode electrode;
an anode flow plate connected to the anode electrode; and
a gap portion provided on a cathode electrode surface, supplying oxygen in concentration greater than or equal to a consuming oxygen amount of the cathode electrode by diffusion;
a container unit containing the cell stack, having one face and another face in a direction parallel to a stacking direction of the unit cells;
a duct unit arranged on at least one of the one face and the another face, and connected to the gap portion;
an oxidant supplying unit which supplies the oxygen to the duct unit;
a mixing tank which stores fuel, configured to supply a mixture of exhausts ejected from the cell stack and high concentration fuel, to the cell stack; and
a circulation pump configured to circulate the fuel to the cell stack.

10. The system of claim 9, wherein the cell stack comprises:
a first unit cell including a first membrane electrode assembly with a first anode electrode and a first cathode electrode, and a first anode flow plate connected to the first anode electrode;
a second unit cell including a second membrane electrode assembly with a second anode electrode and a second cathode electrode, and a second anode flow plate connected to the second anode electrode and facing against the first cathode electrode; and
a contact arranged at a gap portion between the first cathode electrode and the second anode flow plate, electrically connecting the first unit cell and the second unit cell; and
wherein the cell stack satisfies a relationship of
L<((8FhD_{O2})Cₒᵤₜ/i)^{0.5}
where F is a Faraday constant, D_{O2} is a diffusion coefficient of oxygen, Cₒᵤₜ is an oxygen concentration of atmosphere, i is a current density at a time of power generation including oxygen consumption effect by crossover fuel, h is a distance of the gap portion between the first cathode electrode and the second anode flow plate, and a length of the first cathode electrode in a direction perpendicular to the another face is L when the first cathode electrode is connected to the duct unit on one of the one face and the another face, or 2L when the first cathode electrode is connected to duct units on the one face and the another face.

11. The system of claim 9, wherein the cell stack comprises:
a first unit cell including a first membrane electrode assembly with a first anode electrode and a first cathode electrode, and a first anode flow plate connected to the first anode electrode;
a second unit cell including a second membrane electrode assembly with a second anode electrode and a second cathode electrode, and a second anode flow plate connected to the second anode electrode, the second cathode electrode facing against the first cathode electrode; and
a contact arranged at a gap portion between the first cathode electrode and the second cathode electrode, electrically connecting the first unit cell and the second unit cell; and
wherein the cell stack satisfies a relationship of
L<((8FhD_{O2})Cₒᵤₜ/i)^{0.5}
where F is a Faraday constant, D_{O2} is a diffusion coefficient of oxygen, Cₒᵤₜ is an oxygen concentration of atmosphere, i is a current density at a time of power generation including oxygen consumption effect by crossover fuel, 2h is a distance of the gap portion between the first cathode electrode and the second cathode electrode, and each length of the first cathode electrode and the second cathode electrode in a direction perpendicular to the another face is L when the first cathode electrode and the second cathode electrode are connected to the duct unit on one of the one face and the another face, or 2L when the first cathode electrode and the second cathode electrode are connected to duct units on the one face and the another face.

12. The system of claim 10, wherein the cell stack further comprises a porous member in contact with the first cathode electrode, which satisfies a relationship of h=h1+epsilon d, where epsilon is a porosity of the porous member, d is a thickness of the porous member, and h1 is a distance of the gap portion between a surface of the porous member and the second anode flow plate.

13. The system of claim 10, further comprising a diaphragm formed between the duct unit and the container unit.

14. The system of claim 10, further comprising a radiator fin disposed in the duct unit.
